(19) United States
(12) Patent Application Publication
(10) Pub. No.: US 2022/0410882 A1
(43) Pub. Date: Dec. 29, 2022

(54) INTERSECTION COLLISION MITIGATION RISK ASSESSMENT MODEL

(71) Applicant: GM Global Technology Operations LLC, Detroit, MI (US)

(72) Inventors: Lawrence Andrew Bush, Shelby Township, MI (US); Prabhjot Kaur, Troy, MI (US)

(21) Appl. No.: 17/360,086

(22) Filed: Jun. 28, 2021

(51) Int. Cl. B60W 30/095; B60W 60/00; B60W 50/14; B60W 40/08; G06N 20/00

(52) U.S. Cl. CPC B60W 30/0956; B60W 60/0015; B60W 50/14; B60W 40/08; G06N 20/00; B60W 2420/42; B60W 2540/229

(57) ABSTRACT

A vehicle includes a system and method of navigating the vehicle. The system includes a sensor and a processor. The sensor captures an image of a roadway. The processor focuses the sensor at a road segment selected from a plurality of road segments of the roadway using a machine learning program based on a risk of the road segment. The machine learning program is trained to focus the sensor by calculating the risk for each of the plurality of road segments of the roadway based on a hazard probability associated with each road segment and an occupancy probability associated with each road segment, selecting the road segment from the plurality of road segments based on the risk associated with the road segment, and determining a reduction in the risk for a road risk model of the roadway due to selecting the road segment.

### INTRODUCTION

The subject disclosure relates to mitigating risk for a vehicle entering a road section and, in particular, to a system and method for calculating a risk for an intersection and operating the vehicle according to the calculated risk.

The risk of a vehicle having an accident increases when the vehicle passes through an intersection due to the presence of cross-traffic, changing speeds, changing light conditions, pedestrians crossing at the intersection, etc. Therefore, an autonomous vehicle entering the intersection needs to take additional measurements of the traffic condition of its environment to ensure that it can pass through the intersection without incident. To be effective, such measurements and subsequent calculations need to be performed in real time. Accordingly, it is desirable to provide a simple method of assessing a risk to the vehicle of passing through an intersection based on current traffic conditions.

### SUMMARY

In one exemplary embodiment, a method of navigating a vehicle is disclosed. An image of a roadway is obtained from a sensor. The sensor is focused at a road segment selected from a plurality of road segments of the roadway, wherein the road segment is selected using a machine learning program based on a risk of the road segment. The machine learning program is trained to select the road segment by calculating the risk for each of the plurality of road segments of the roadway, wherein the risk associated with the road segment is based on a hazard probability associated with the road segment and an occupancy probability associated with the road segment, selecting the road segment from the plurality of road segments based on the risk associated with the road segment, and determining a reduction in risk for a road risk model of the roadway due to selecting the road segment.

In addition to one or more of the features described herein, calculating the risk for the road segment further includes calculating a product of the hazard probability for the road segment and the occupancy probability for the road segment. Focusing the sensor further includes performing a random selection process on the plurality of road segments in which a probability of selecting the road segment is based on the risk associated with the road segment. The method further includes alerting a driver of the vehicle when an attention of the driver of the vehicle is not on the road segment. The method further includes directing the attention of the driver to the road segment using a haptic signal. The method further includes comparing the risk of the road risk model to a risk metric and rewarding the machine learning program for selecting the road segment when the risk is less than the risk metric. In an embodiment, the sensor includes a first sensor and a second sensor and the method further includes focusing the first sensor on the road segment while maintaining a wide field of view of the roadway with the second sensor.

In another exemplary embodiment, a system for navigating a vehicle is disclosed. The system includes a sensor and a processor. The sensor is configured to capture an image of a roadway. The processor is configured to focus the sensor at a road segment selected from a plurality of road segments of the roadway using a machine learning program based on a risk of the road segment. The machine learning program is trained to focus the sensor by calculating the risk for each of the plurality of road segments of the roadway, wherein the risk associated with the road segment is based on a hazard probability associated with the road segment and an occupancy probability associated with the road segment, selecting the road segment from the plurality of road segments based on the risk associated with the road segment, and determining a reduction in the risk for a road risk model of the roadway due to selecting the road segment.

In addition to one or more of the features described herein, the processor is further configured to calculate the risk for the road segment by calculating a product of the hazard probability for the road segment and the occupancy probability for the road segment. The processor is further configured to focus the sensor by performing a random selection process on the plurality of road segments in which a probability of selecting the road segment is based on the risk associated with the road segment. The processor is further configured to alert a driver of the vehicle when an attention of the driver is not on the road segment. The processor is further configured to direct the attention of the driver to the road segment using a haptic signal. The processor is further configured to train the machine learning program by comparing the risk of the road risk model to a risk metric and rewarding the machine learning program for selecting the road segment when the risk is less than the risk metric. In an embodiment, the sensor includes a first sensor and a second sensor and the processor is further configured to focus the first sensor on the road segment while maintaining a wide field of view of the roadway with the second sensor.

In yet another exemplary embodiment, a vehicle is disclosed. The vehicle includes a sensor and a processor. The sensor is configured to capture an image of a roadway. The processor is configured to focus the sensor at a road segment selected from a plurality of road segments of the roadway using a machine learning program based on a risk of the road segment. The machine learning program is trained to focus the sensor by calculating the risk for each of the plurality of road segments of the roadway, wherein the risk associated with the road segment is based on a hazard probability associated with the road segment and an occupancy probability associated with the road segment, selecting the road segment from the plurality of road segments based on the risk associated for the road segment, and determining a reduction in the risk for a road risk model of the roadway due to selecting the road segment.

In addition to one or more of the features described herein, the processor is further configured to calculate the risk for the road segment by calculating a product of the hazard probability for the road segment and the occupancy probability for the road segment. The processor is further configured to focus the sensor by performing a random selection process on the plurality of road segments in which a probability of selecting the road segment is based on the risk associated with the road segment. The processor is further configured to direct an attention of a driver of the vehicle to the road segment using a haptic signal when the attention of the driver is not on the road segment. The processor is further configured to train the machine learning program by comparing the risk of the road risk model to a risk metric and rewarding the machine learning program for selecting the road segment when the risk is less than the risk metric. In an embodiment, the sensor includes a first sensor and a second sensor and the processor is further configured to focus the first sensor on the road segment while maintaining a wide field of view of the roadway with the second sensor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a vehicle in accordance with an exemplary embodiment;

FIG. 2 shows a driver alert system for the vehicle of FIG. 1, in an embodiment;

FIG. 3 shows a top plan view of an intersection, in an illustrative embodiment;

FIG. 4 shows a complete hazard probability map of the intersection for FIG. 3 for the host vehicle as the host vehicle is approaching the intersection;

FIG. 5 shows the hazard probability map of the intersection for FIG. 3 when the host vehicle is at the intersection;

FIG. 6 shows an occupancy probability map of the intersection of FIG. 3;

FIG. 7 shows an image of an illustrative intersection as viewed by a host vehicle approaching the intersection;

FIG. 8 shows a close-up of a selected road segment of the intersection;

FIG. 9 shows a block diagram of a process for training a machine learning program to focus a sensor at a road segment, in an embodiment;

FIG. 10 shows a flowchart for a method of alerting a passenger or deriving of the vehicle to a risk within an intersection; and

FIG. 11 shows a flowchart of a method for determining a risk of an intersection or road segment that includes the possibility of an object being occluding from view of the sensing system.

### DETAILED DESCRIPTION

The following description is merely exemplary in nature and is not intended to limit the present disclosure, its application or uses. It should be understood that throughout the drawings, corresponding reference numerals indicate like or corresponding parts and features.

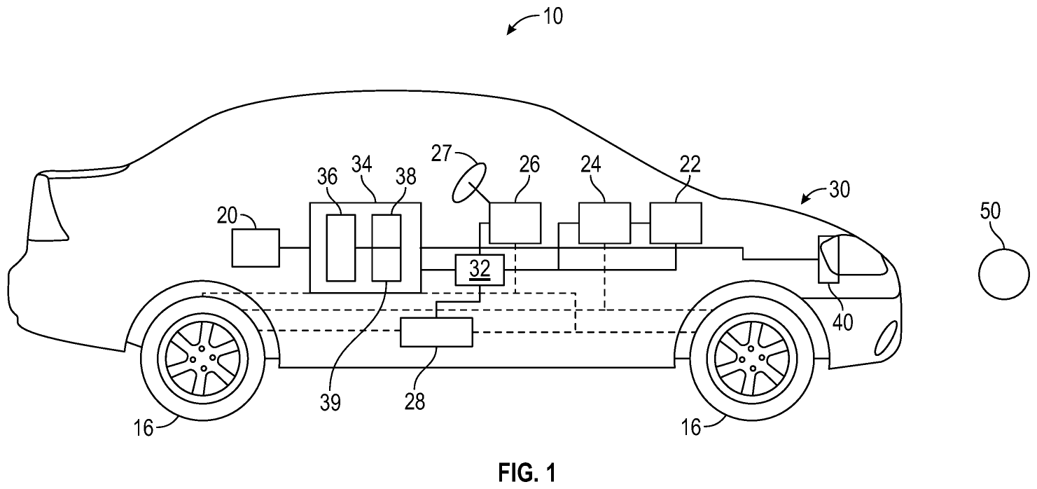

In accordance with an exemplary embodiment, FIG. 1 shows a vehicle 10. The vehicle 10 can be autonomous or semi-autonomous, in various embodiments. In an exemplary embodiment, the vehicle 10 is a so-called Level Four or Level Five automation system. A Level Four system indicates “high automation,” referring to the driving mode-specific performance by an automated driving system of all aspects of the dynamic driving task, even if a human driver does not respond appropriately to a request to intervene. A Level Five system indicates “full automation,” referring to the full-time performance by an automated driving system of all aspects of the dynamic driving task under all roadway and environmental conditions that can be managed by a human driver. It is to be understood that the system and methods disclosed herein can also be used with a vehicle operating at any of Levels One through Five.

The vehicle 10 generally includes at least a navigation system 20, a propulsion system 22, a transmission system 24, a steering system 26, a brake system 28, a sensing system 30, an actuator system 32, and a controller 34. The navigation system 20 determines a road-level route plan for automated driving of the vehicle 10. The propulsion system 22 provides power for creating a motive force for the vehicle 10 and can, in various embodiments, include an internal combustion engine, an electric machine such as a traction motor, and/or a fuel cell propulsion system. The transmission system 24 is configured to transmit power from the propulsion system 22 to two or more wheels 16 of the vehicle 10 according to selectable speed ratios. The steering system 26 influences a position of the two or more wheels 16. While depicted as including a steering wheel 27 for illustrative purposes, in some embodiments contemplated within the scope of the present disclosure, the steering system 26 may not include a steering wheel 27. The brake system 28 is configured to provide braking torque to the two or more wheels 16.

The sensing system 30 includes sensors or detectors that sense an object 50 in an exterior environment of the vehicle 10 and determines various parameters of the object that are useful in locating the position and relative velocities of various remote vehicles in the environment of the autonomous vehicle. Such parameters can be provided to the controller 34. The sensing system 30 can include a first sensor and a second sensor. In various embodiments, the first sensor can be used to focus on a selected segment of a road or an intersection while the second sensor is used to obtain a wide field-of-view of the road or intersection. The first sensor can change its field of view from wide to narrow and can also change its orientation. In an embodiment, the sensing system 30 includes one or more digital cameras for capturing one or more images of the road or intersection. In alternative embodiments, the sensing system 30 can include one more of a radar system, Lidar, etc., for detecting range, relative velocities, azimuth, and elevation of an object 50 such as a target vehicle, a pedestrian, etc.

The controller 34 includes a processor 36 and a computer readable storage device or computer readable storage medium 38. The storage medium includes programs or instructions 39 that, when executed by the processor 36, operate the vehicle 10 based on outputs from the sensing system 30. The controller 34 can build a trajectory for the vehicle 10 based on the output of sensing system 30 and can provide the trajectory to the actuator system 32 to control the propulsion system 22, transmission system 24, steering system 26, and/or brake system 28 in order to navigate the vehicle 10 with respect to the object 50.

The computer readable storage medium 38 may further include programs or instructions 39 that when executed by the processor 36, determines a risk to the vehicle 10 of a traffic scenario, particularly at an intersection. The controller 34 can provide an alert to a driver of the vehicle 10 and/or control an operation of the vehicle based on the risk. In various embodiments, the controller 34 can also accelerate and/or decelerate the vehicle 10, steer the vehicle, apply brakes, etc. to avoid an incident or collision with the object 50.

The computer readable storage medium 38 may further include programs or instructions 39 that when executed by the processor 36, focuses a sensor on a selected road segment of the roadway based on a risk associated with the road segment. The sensor can be focused using a machine learning program, such as a neural network. The machine learning program can be trained to focus the sensor using real or simulated data, as described herein.

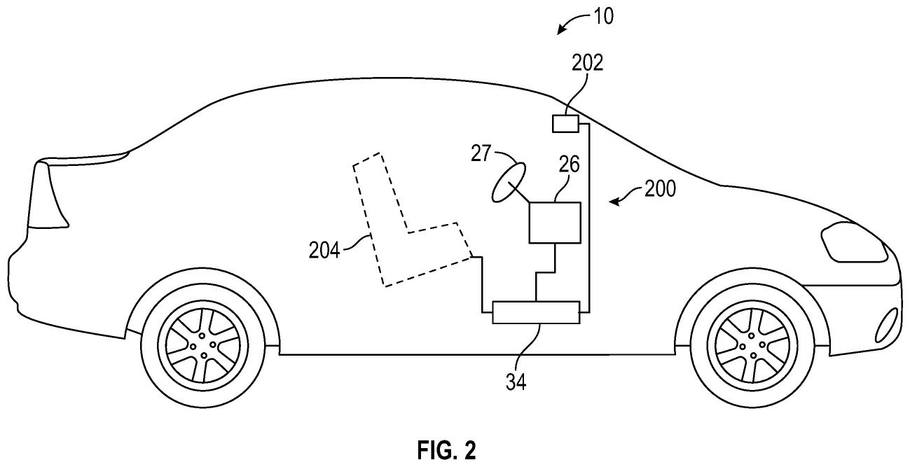

FIG. 2 shows a driver alert system 200 for the vehicle 10 of FIG. 1, in an embodiment. The driver alert system 200 includes a driver-monitoring device 202 that observes the driver and the driver's attention level. The driver-monitoring device 202 can be an eye monitoring or biometric sensor that indicates a level or direction of the driver's attention, in various embodiments. Data from the driver-monitoring device 202 is provided to the controller 34. The controller 34 is in communication with the steering system 26 and/or a driver's seat 204. The controller 34 compares a focus of the sensing system (e.g., a focus of one of the first sensor and the second sensor) and provides an alarm to the driver when the driver's attention differs from the focus of the sensing system 30. The controller 34 can sound an alarm or provided a haptic warning, such as by vibrating an object in contact with the driver, such as the steering wheel 27 or the driver's seat 204. The driver's seat 204 can have haptic emitters at various places along the driver's seat 204. A haptic emitter corresponding to the direction of focus of the sensing system 30 can be selected when the driver's attention is not aligned with the focus of the sensing system 30. For example, a right-side haptic emitter can be activated to bring the driver's attention to the right side and a left-side haptic emitter can be activated to bring the driver's attention to the left side.

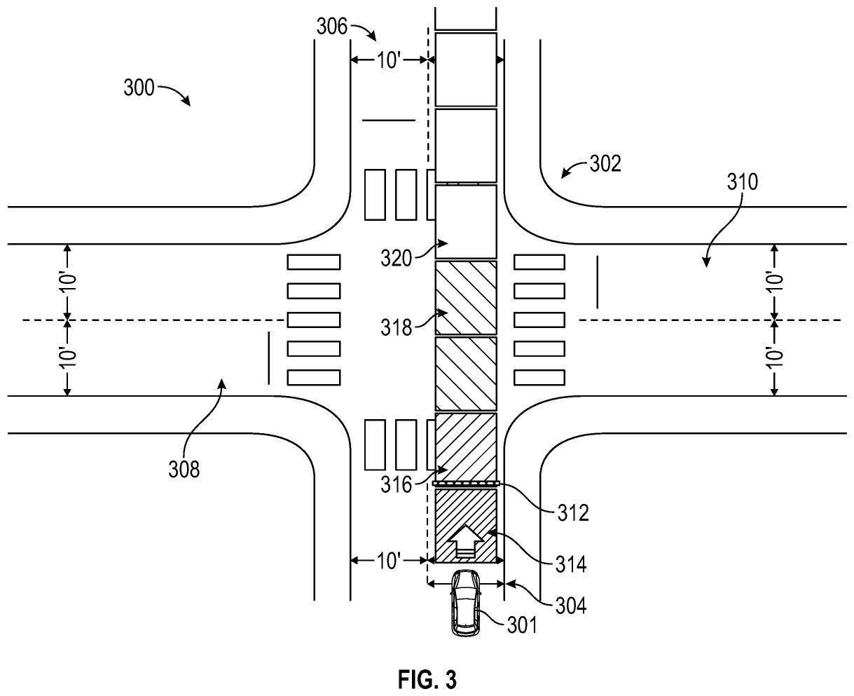

FIG. 3 shows a top plan view 300 of an intersection 302, in an illustrative embodiment. The intersection 302 can have any configuration of suitable traffic indicators, such as a four-way stop sign, a two-way stop sign, traffic lights, in various embodiments. For purposes of illustration, the top plan view 300 includes a selected lane 304 by which a host vehicle 301 (such as the vehicle 10 of FIG. 1) approaches the intersection 302, an oncoming lane 306 which allows traffic to move in a direction opposite the selected lane, a first cross-traffic lane 308 and a second cross-traffic lane 310. A stop line 312 in the selected lane 304 indicates a place for the host vehicle 301 to stop when approaching the intersection 302, given a stop sign or red-light condition for the selected lane 304.

FIG. 3 also shows, in part, a model for determining hazard probabilities within the selected lane 304. The controller 34 partitions the selected lane 304 into a plurality of road segments according to a segmentation algorithm model and assigns a hazard probability to each road segment. The hazard probability indicates a probability of an accident or of a hazardous encounter for the host vehicle 301 when an object 50 such as a target vehicle is in the road segment. The hazard probability does not require that such an object 50 be present in the road segment and the value of the hazard probability is independent of whether an object is in the road segment or not. The selected lane 304 shows a plurality of road segments ahead of the vehicle 10.

Each road segment is shaded to indicate a range for a hazard probability associated with the road segment. For example, a first leading road segment 314 immediately ahead of the host vehicle 301 has a high hazard probability associated with it, as there is a high probability of collision if a target vehicle is in it. A second leading road segment 316 further from the host vehicle 301 and has a medium hazard probability associated with it, due primarily to the additional time available for the host vehicle 301 to react to a target vehicle in it. Similarly, a third leading road segment 318 has a low hazard probability associated with it, and a fourth leading road segment 320 has a very low hazard probability associated with it. In various embodiments, the high hazard probability is between about 0.75 and 1, the medium hazard probability is between about 0.5 and about 0.75, the low hazard probability is between about 0.25 and 0.5, and the very low hazard probability is between 0 and about 0.25.

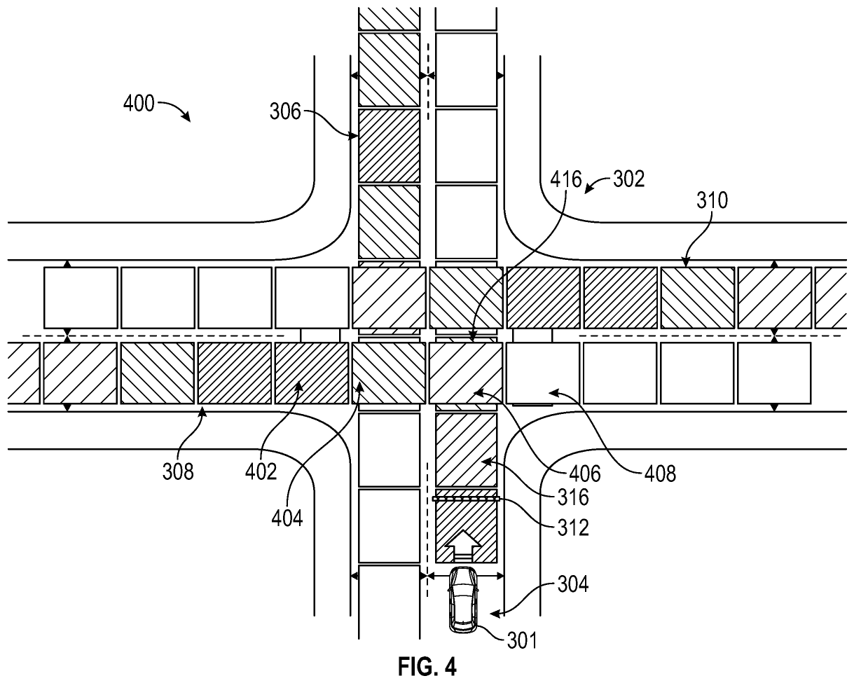

FIG. 4 shows a complete hazard probability map 400 of the intersection 302 for FIG. 3 for the host vehicle 301 as the host vehicle is approaching the intersection 302. Each of the selected lane 304, the oncoming lane 306 and the first cross-traffic lane 308 and the second cross-traffic lane 310 are partitioned by the controller 34 and relevant hazard probabilities are assigned.

As illustrated in FIG. 4, a road segment in one lane (such as second leading road segment 416 in selected lane 304) can overlap a road segment in a crossing lane (such as third crossing road segment 406 in the first cross-traffic lane 308). It is to be understood that each of these overlapping road segments can have a different hazard probability due to the relative direction of traffic associated with each road segment.

Also as illustrated in FIG. 4, the hazard probability for a road segment can be based on a speed that a target vehicle within the road segment would have as well as a current state of the host vehicle 301. The state of the host vehicle 301 includes a location of the host vehicle with respect to the intersection and the current speed of the host vehicle, etc. The hazard probability model can also account for various possible maneuvers for the host vehicle 301, such as a left turn, right turn, moving straight through the intersection, etc., in determining the hazard probability. Hazard probabilities can be pre-calculated before the host vehicle 301 arrives at the intersection 302.

A first crossing road segment 402, second crossing road segment 404, third crossing road segment 406 and fourth crossing road segment 408 illustrates the effects of assumed target vehicle speed on the hazard probability. With respect to the first crossing road segment 402, although this road segment is away from the intersection, a target vehicle in this road segment given its assumed speed is on a collision course with the host vehicle 301.

The second crossing road segment 404 has a medium hazard probability because a target vehicle in this road segment having an assumed speed has a less likely probability of collision with the host vehicle 301. Similarly, the third crossing road segment 406 has a low hazard probability because a target vehicle in this road segment would most likely move out of the path of the host vehicle 301 by the time the host vehicle reaches this road segment. Similarly, fourth crossing road segment 408 has a very low hazard probability due to its relative inaccessibility by the host vehicle 301.

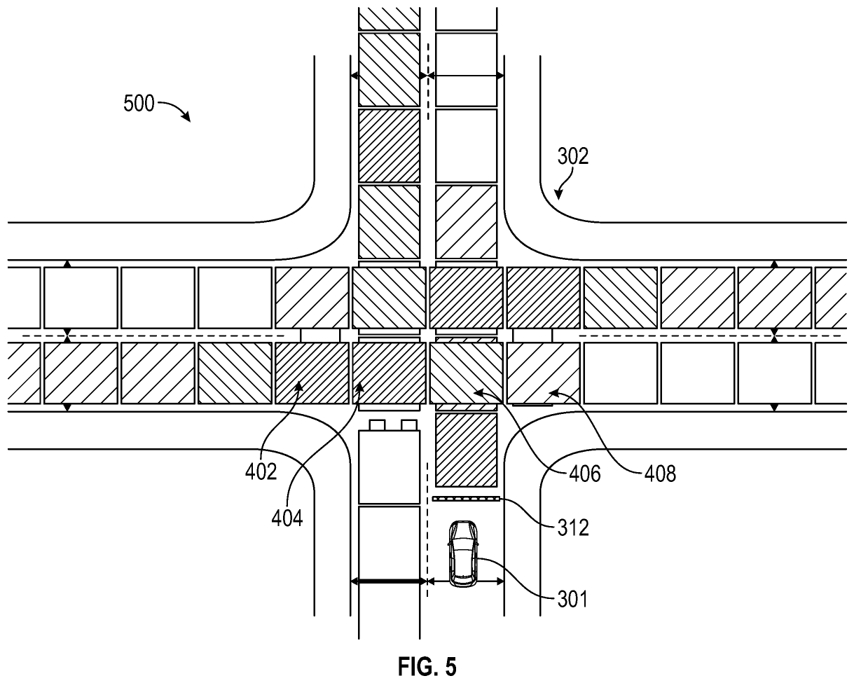

FIG. 5 shows a hazard probability map 500 of the intersection 302 for FIG. 3 when the host vehicle 301 is at the intersection 302. A comparison of FIG. 4 and FIG. 5 illustrates how the hazard probability for each road segment changes based on the state of the host vehicle 301. While the hazard probability for the first crossing road segment 402 remains high, the probability of the second crossing road segment 404 has changed from medium (in FIG. 4) to high (in FIG. 5). Similarly, the hazard probability of the third crossing road segment 406 has changed from low (in FIG. 4) to a medium (in FIG. 5), and the hazard probability of the fourth crossing road segment 408 has changed from very low (in FIG. 4) to low (in FIG. 5).

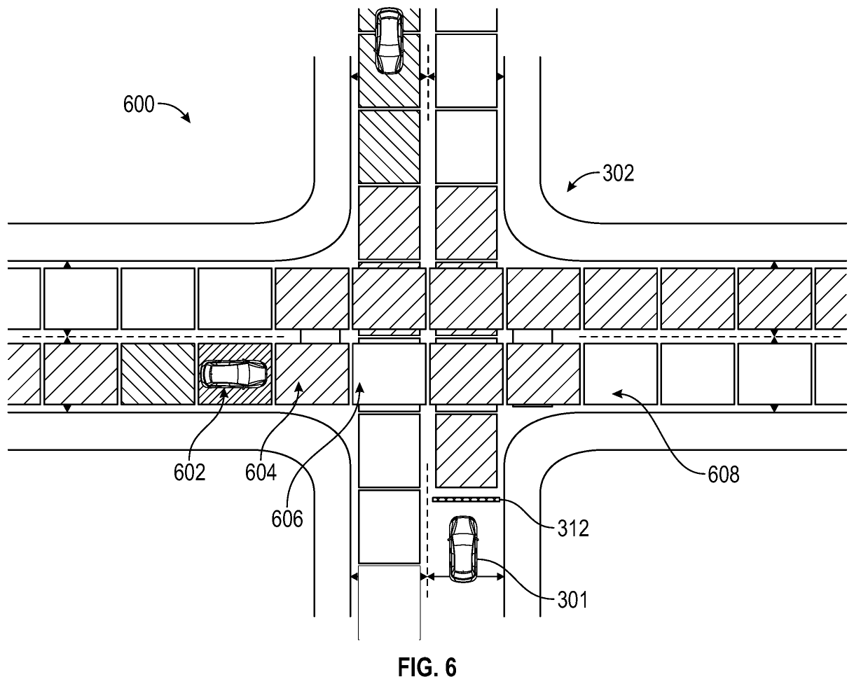

FIG. 6 shows an occupancy probability map 600 of the intersection 302 of FIG. 3. The occupancy probability map 600 is based on detections made by the sensing system 30. The occupancy probability map 600 shown in FIG. 6 is for a time at which the host vehicle 301 is stopped at the intersection. The detections are input to a selected model, such as a Markov dynamics model or a Bayes sensing model to determine an occupancy probability for a plurality of road segments. For example, these models can determine a high occupancy road segment 602 corresponding to the location of the detections, but also a medium occupancy road segment 604 which is nearby. A low occupancy road segment 606 is more distant from the location of the detections, while a very low occupancy road segment 608 is even more distant.

Once the hazard probability and the occupancy probability are known, a risk can be calculated for each road segment and for the entire intersection. The risk for a selected road segment (n^{th} road segment) is the product of the occupancy probability for the road segment and the hazard probability for the road segment, as shown in Eq. (1):

Riskₙ=P(Oₙ)×P(Cₙ) Eq. (1)

where P(Oₙ) is the occupancy probability of the n^{th} road segment and P(Cₙ) is the hazard probability of the n^{th} road segment. The risk for the entire intersection is a summation of the risks for the plurality of road segments of the intersection, as shown in Eq. (2)

Risk(Intersection)=Σₙ₌₁^{N}P(Oₙ)×P(Cₙ) Eq. (2)

where N is the total number of road segments. The determined risk for the intersection can be compared to a warning threshold to send a signal to the processor or to the driver to prevent the host vehicle 301 from moving into a situation in the intersection in which an accident can occur.

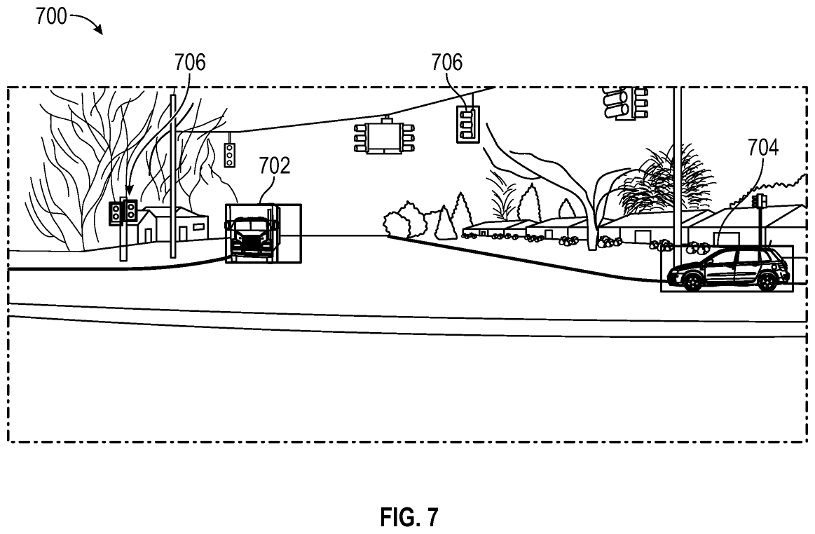

FIG. 7 shows an image 700 of an illustrative intersection as viewed by a host vehicle 301 approaching the intersection. The image 700 shows a first target vehicle 702 in the oncoming lane and a second target vehicle 704 in a cross-traffic lane. The image 700 also includes traffic lights 706. The controller 34 isolates the first target vehicle 702 and the second target vehicle 704 using bounding boxes, which can then be used to identify the vehicles. The controller 34 also isolates the traffic lights 706 in order to help identify a state of the traffic lights.

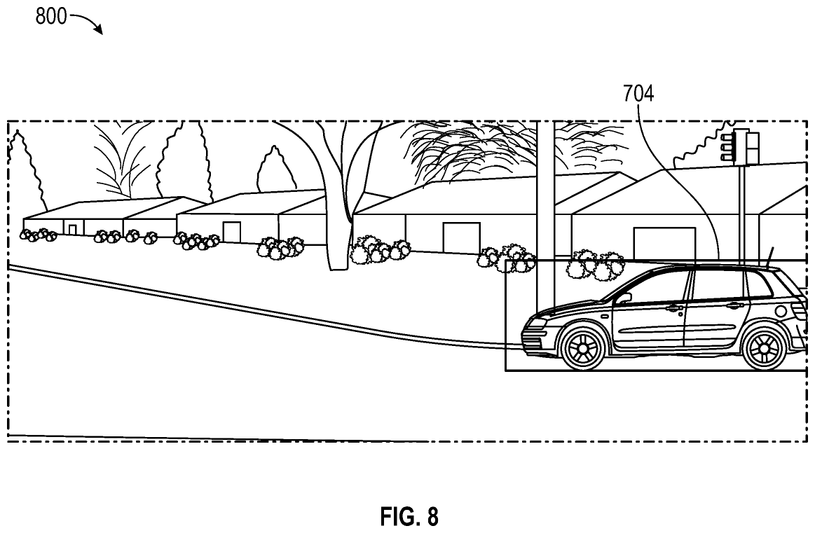

FIG. 8 shows a close-up of a selected road segment of the intersection. In various embodiments, the controller 34 identifies a road segment having a highest associated risk (e.g., the road segment of the second target vehicle 704) and then focuses a field of view of the sensing system 30 on the high risk road segment to mitigate the risk. The focusing can be performed using one of the first sensor and the second sensor of the sensing system 30. While one of the first sensor and the second sensor focuses on a selected road segment, the other of the first sensor and the second sensor maintains a wide field of view of the intersection. By focusing a sensor on a selected road segment, the controller 34 can obtain an updated occupancy probability and risk value for the selected road segments. The updated occupancy probability can be used to update the risk for the entire intersection.

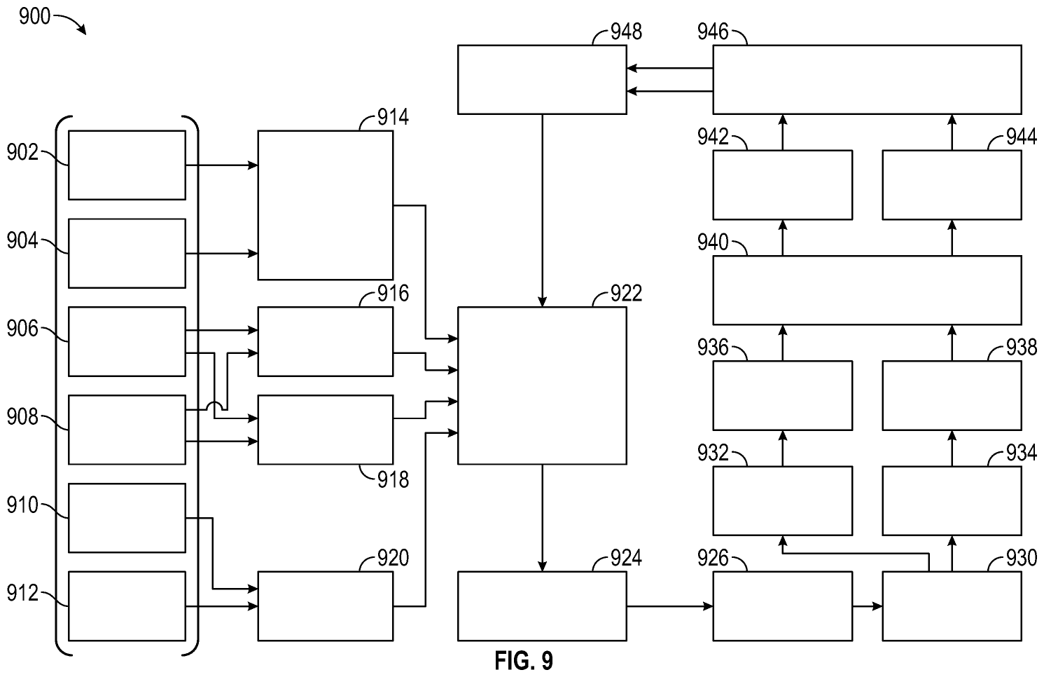

FIG. 9 shows a block diagram 900 of a process for training a machine learning program to focus a sensor at a road segment, in an embodiment. The process takes inputs from various sensors and determines features of the roadway based on the inputs. These features are input to a machine learning program that implements a stochastic selection policy for selecting a road segment upon which to focus a sensor. A road risk model is then determined based on the sensor focus. The road risk model defines a risk associated with the entire roadway and can be used to train the machine learning program.

The inputs for training the machine learning program can come from many sources. A road importance model 902 and an intersection map 904 can be provided from a database or remote server. Camera data 906 and other sensor data 908 can come from the various components of the sensing system 30 such as the digital camera 40 and/or radar, Lidar, etc. The salience 910 of the intersection and the prior focus location data 912 can be stored in the computer readable storage medium 38 or the controller 34, for example.

The road importance model 902 and the intersection map 904 are used to determine a wide field-of-view image 914 of the road intersection with weightings for a hazard probability map. The camera data 906 and other sensor data 908 are used to the perform the road segmentation 916 and determine prior vehicle detections 918 of objects in the road, along with their locations and velocities. The salience 910 of the intersection and the prior focus location data 912 are used to create an uncertainty map 920 that can be used to train the machine learning program 922.

The machine learning program 922 can be a neural network, a Gaussian process machine, a support vector machine or other suitable machine learning program. The wide field-of-view image 914, road segmentation 916, prior vehicle detections 918 and the uncertainty map 920 are provided to the machine learning program 922. The machine learning program 922 receives these features and training data 948 and implements a stochastic policy 924 for selecting a road segment for focus by the sensor. The stochastic policy 924 includes randomly selecting a road segment based on the weights of the road segment. The risk for the road segment is used as a weight for the road segment in the random selection process. The probability of a road segment being selected using the random selection process is related to the risk associated with the road segment. For example, a road segment having a high associated risk is more likely to be selected than a road segment having a low associated risk.

The random selection process outputs a selected road segment 926 for closer focus. A simulation 930 is then performed to determine a road risk model based on the selection of the selected road segment. In the simulation, the first sensor is made to focus on the selected road segment to obtain a narrow FOV camera image 932. A second sensor remains on the wide field-of-view of the intersection of the simulation to obtain a wide FOV camera image 934. In general, the narrow FOV image of is a high-resolution image, while the wide FOV image of the intersection is a lower resolution image.

The first sensor observes the narrow FOV to obtain any narrow FOV vehicle detections 936. The second sensor observes the wide FOV to obtain any wide FOV vehicle detections 938. The narrow FOV vehicle detections 936 and the wide FOV vehicle detections 938 are used at an occupancy grid calculator 940 to calculate a focused occupancy grid 942 for the intersection and an unfocused occupancy grid 944 for the intersection. The values of the focused occupancy grid 942 and of the unfocused occupancy grid 944 are used to update a road risk model 946 for the intersection, which can be used as training data 948 in a subsequent iteration of a training step for training the machine learning program 922. The road risk model 946 indicates whether the focusing of the sensor at the selected road segment via the focused occupancy grid 942 lowers or decreases the risk with respect to the unfocused occupancy grid 944. The machine learning program 922 can be rewarded when focusing the sensor at a selected road segment decreases the risk associated with the road risk model or punished when focusing the sensor increases the risk. In various embodiments, the risk associated with the road risk model can be compared to a risk metric and the machine learning program can be rewarded when the risk due to focusing the sensor is less than the risk metric.

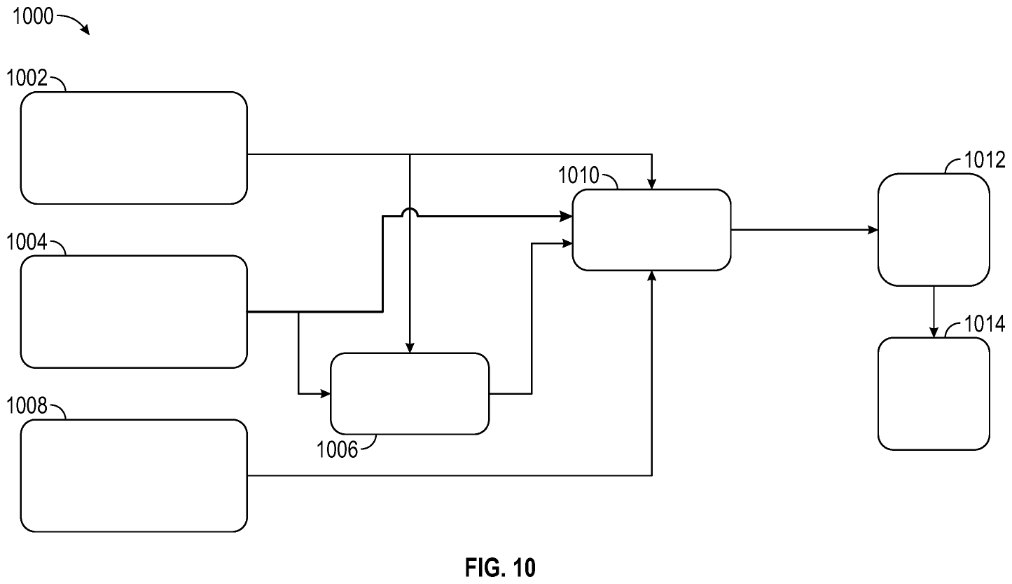

FIG. 10 shows a flowchart 1000 for a method of alerting a passenger or driver of the host vehicle 301 to a risk within an intersection. In box 1002, the probability of occupancy for a road segment is determined. In box 1004, the probability of collision for the road segment is determined. The probability of occupancy and probability of collision are provided to a focusing model 1006 that determines the risk associated with the road segment. The focusing model 1006 determines a selected road segment of interest that has a high risk associated with it. The sensor is generally focused on the selected road segment. The machine learning program 922, having been trained, operates the focusing model 1006 to select a road segment for sensor focusing.

In box 1008, driver monitoring is performed in order to determine where the driver is focusing his attentions. The driving monitoring can be performed using eye sensors, for example, that track the location or orientation of the driver's eyes.

In box 1010, the selected road segment and the driver focus are provided to a disparity mapping module that determines a difference between the selected road segment and the driver's focus or attention. When there is a difference between the driver focus and the selected road segment (i.e., when the driver is not paying attention to the road segment having the greatest risk), an awareness signal can be generated to alert the driver.

In box 1012, the selected road segment is mapped to a haptic actuator. The haptic signal can be assigned to one or many haptic actuators, for example, on a driver's seat. A selected haptic signal can be transmitted in order to focus the driver's attention to a selected location within the roadway. For example, the haptic actuators can include a first vibration device on a left side of the driver's seat and a second device on a right side of the driver's seat. When a selected road segment is on the driver's left side, the first vibration device can be actuated and when the selected road segment is on the driver's right side, the second vibration device can be actuated. In addition, the intensity of the haptic signal can be high to indicate a high level of risk and concern and can be low to indicate a low level of risk and concern. In box 1014, the mapped haptic signal is sent to a haptics controller to actuate the corresponding haptic actuator.

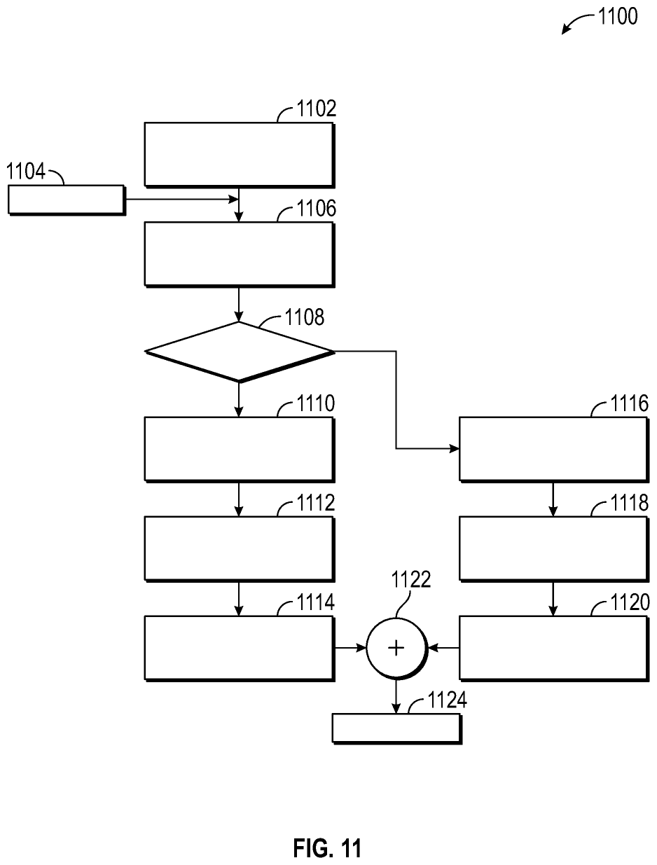

FIG. 11 shows a flowchart 1100 of a method for determining a risk of an intersection or road segment that includes the possibility of an object being occluded from view of the sensing system 30. In box 1102, a prior belief of the state of the intersection is produced. In box 1104, observations from sensors are provided. From the prior belief and observations, a probability of occlusion is determined. In box 1106, the probability of occlusion is updated based on the prior belief and observations using a Bayesian update process.

In box 1108, the probability of no occlusion is sent down a processing path for the no occlusion scenario and a probability of occlusion is sent down a processing path for the occlusion scenario. These processing paths are run in parallel to each other. Along the processing path for the no occlusion scenario, in box 1110, a system dynamics model is run on the intersection assuming no occlusion. In box 1112, an updated belief of state of the intersection is arrived at based on the system dynamics model. In box 1114, the updated state is multiplied by the probability of no occlusion to generate a weighted no occlusion state.

Similarly, along the processing path for the occlusion scenario, in box 1116, a system dynamics model is run on the intersection assuming there is an occlusion. In box 1118, an updated belief of state of the intersection is arrived at based on the system dynamics model. In box 1120, the updated state is multiplied by the probability of occlusion to generate a weighted occlusion state. At summations box 1122, the weighted non occlusion state and the weighted occlusion state are added together to determine the risk associated with the selected road segment in box 1124.

While the method has been discussed with respect to a vehicle approaching an intersection, the method can also be applied to other roadways, such as a straight road section, a divided road, an undivided road, a curved road. The risk can be based on any type of intersection configuration and calculations can include the effect of obstructions, such as a building, hedge, or hill, on the occurrence of detections at a sensor.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of navigating a vehicle, comprising:
obtaining an image of a roadway from a sensor; and
focusing the sensor at a road segment selected from a plurality of road segments of the roadway, wherein the road segment is selected using a machine learning program based on a risk of the road segment, the machine learning program being trained to select the road segment by:
calculating the risk for each of the plurality of road segments of the roadway, wherein the risk associated with the road segment is based on a hazard probability associated with the road segment and an occupancy probability associated with the road segment;
selecting the road segment from the plurality of road segments based on the risk associated with the road segment; and
determining a reduction in risk for a road risk model of the roadway due to selecting the road segment.

2. The method of claim 1, wherein calculating the risk for the road segment further comprises calculating a product of the hazard probability for the road segment and the occupancy probability for the road segment.

3. The method of claim 1, wherein focusing the sensor further comprises performing a random selection process on the plurality of road segments in which a probability of selecting the road segment is based on the risk associated with the road segment.

4. The method of claim 1, further comprising alerting a driver of the vehicle when an attention of the driver of the vehicle is not on the road segment.

5. The method of claim 4, further comprising directing the attention of the driver to the road segment using a haptic signal.

6. The method of claim 1, further comprising comparing the risk of the road risk model to a risk metric and rewarding the machine learning program for selecting the road segment when the risk is less than the risk metric.

7. The method of claim 1, wherein the sensor includes a first sensor and a second sensor, further comprising focusing the first sensor on the road segment while maintaining a wide field of view of the roadway with the second sensor.

8. A system for navigating a vehicle, comprising:
a sensor configured to capture an image of a roadway; and
a processor configured to:
focus the sensor at a road segment selected from a plurality of road segments of the roadway using a machine learning program based on a risk of the road segment, wherein the machine learning program is trained to focus the sensor by:
calculating the risk for each of the plurality of road segments of the roadway, wherein the risk associated with the road segment is based on a hazard probability associated with the road segment and an occupancy probability associated with the road segment;
selecting the road segment from the plurality of road segments based on the risk associated with the road segment; and
determining a reduction in the risk for a road risk model of the roadway due to selecting the road segment.

9. The system of claim 8, wherein the processor is further configured to calculate the risk for the road segment by calculating a product of the hazard probability for the road segment and the occupancy probability for the road segment.

10. The system of claim 8, wherein the processor is further configured to focus the sensor by performing a random selection process on the plurality of road segments in which a probability of selecting the road segment is based on the risk associated with the road segment.

11. The system of claim 8, wherein the processor is further configured to alert a driver of the vehicle when an attention of the driver is not on the road segment.

12. The system of claim 11, wherein the processor is further configured to direct the attention of the driver to the road segment using a haptic signal.

13. The system of claim 8, wherein the processor is further configured to train the machine learning program by comparing the risk of the road risk model to a risk metric and rewarding the machine learning program for selecting the road segment when the risk is less than the risk metric.

14. The system of claim 8, wherein the sensor includes a first sensor and a second sensor and the processor is further configured to focus the first sensor on the road segment while maintaining a wide field of view of the roadway with the second sensor.

15. A vehicle, comprising:
a sensor configured to capture an image of a roadway; and
a processor configured to:
focus the sensor at a road segment selected from a plurality of road segments of the roadway using a machine learning program based on a risk of the road segment, wherein the machine learning program is trained to focus the sensor by:
calculating the risk for each of the plurality of road segments of the roadway, wherein the risk associated with the road segment is based on a hazard probability associated with the road segment and an occupancy probability associated with the road segment;
selecting the road segment from the plurality of road segments based on the risk associated for the road segment; and
determining a reduction in the risk for a road risk model of the roadway due to selecting the road segment.

16. The vehicle of claim 15, wherein the processor is further configured to calculate the risk for the road segment by calculating a product of the hazard probability for the road segment and the occupancy probability for the road segment.

17. The vehicle of claim 15, wherein the processor is further configured to focus the sensor by performing a random selection process on the plurality of road segments in which a probability of selecting the road segment is based on the risk associated with the road segment.

18. The vehicle of claim 15, wherein the processor is further configured to direct an attention of a driver of the vehicle to the road segment using a haptic signal when the attention of the driver is not on the road segment.

19. The vehicle of claim 15, wherein the processor is further configured to train the machine learning program by comparing the risk of the road risk model to a risk metric and rewarding the machine learning program for selecting the road segment when the risk is less than the risk metric.

20. The vehicle of claim 15, wherein the sensor includes a first sensor and a second sensor and the processor is further configured to focus the first sensor on the road segment while maintaining a wide field of view of the roadway with the second sensor.
